(19) United States
(12) Patent Application Publication
(10) Pub. No.: US 2010/0084486 A1
(43) Pub. Date: Apr. 8, 2010

(54) HAND STERILIZER GEL DISPENSER WITH LCD MEDIA DISPLAY DEVICE

(76) Inventor: Jae Yun Kim, Seoul (KR)

Correspondence Address: CHRISTOPHER PAUL MITCHELL, 888 16TH ST., NW, SUITE 800, WASHINGTON, DC, 20006, US

(21) Appl. No.: 12/530,191

(22) PCT Filed: Mar. 5, 2008
(86) PCT No.: PCT/KR2008/001246

§ 371 Date: Sep. 4, 2009

(30) Foreign Application Priority Data
Mar. 6, 2007 (KR) 10-2007-0021789

(51) Int. Cl. B67D 7/08

(52) U.S. Cl. 239/71

(57) ABSTRACT

Disclosed is a hand sterilizer dispenser having a display screen which can be uploaded with advertisements and wanted information. This hand sterilizer automatically operates when a hand moves toward a sensor without an additional operation. This sterilizer has a gel type detergent, so drying apparatus process is not needed and has a conventional simple cleaning and sterilizing function. The hand sterilizer having a display device of a compact size performs a display of products, reducing in energy waste, and providing a hand sterilizing function and image of a product for a short time without noise and vibrations.

### TECHNICAL FIELD

This invention is a hand sterilizer dispenser having a display screen which can be uploaded with advertisements and wanted information. This hand sterilizer automatically operates when a hand moves toward a sensor without an additional operation.

This sterilizer has a gel type detergent, so drying apparatus process is not needed and has a conventional simple cleaning and sterilizing function. The hand sterilizer having a display device of a compact size performs a display of products, reducing in energy waste, and providing a hand sterilizing function and image of a product for a short time without noise and vibrations.

### BACKGROUND ART

People's hands are the most useful instrumental means as the largest vector which transmits a contagious and pathogenic microorganism and foreign material directly and indirectly between a person and another person, a person and an object, an object and another object, and a bodily organ and another bodily organ. The hands of people as the largest artificial means which transmits a microorganism, e.g., Microbe, Bacteria, Fungi, Rickettsia, and Protozoas should be maintained and managed to be cleaned through a personal sanitary process, e.g., a cleaning or a washing, which uses flowing water and detergent.

However, although the hands may be managed sanitarily by being washed often with water or soap, personal sanitation is not managed since students or office workers are not accustomed to washing hands or do not a convenient environment to wash hands. An non-sticky gel type hand detergent having alcohol is a useful substitute to soap and water. In particular, it is widely known that an alcohol hand sterilizing liquid removes bacteria and smell by means of natural evaporation of an antiseptic gel and delays an aging process of the skin more than a normal anti-fungal soap, and reduces a skin side effect of spots, blisters, or itching.

In general, a hand sterilizer is an apparatus for performing bacteriostatic or bactericidal activities against a microorganism existing on the surface of the hand by spraying, applting and rubbing various type detergents, e.g., solid or liquid disinfectants. The hand sterilizer is classified into a manual hand sterilizer and an automatic hand sterilizer mechanically according to an applied method.

The manual hand sterilizer is a hand cleaning apparatus which sterilizes the hand by spraying an antiseptic solution through a signal transmission according to a mechanical switch. The automatic hand sterilizer is a sterilizing apparatus which automatically sprays an antiseptic solution to a hand if the hand is detected on by an infrared ray sensor which detects objects. The automatic hand sterilizer is preferred of the two.

However, a conventional automatic hand sterilizer includes a sterilizing unit with a dryer, and has a merit which sterilizes the hand by spraying a lotion type hand antiseptic solution on the hand and dries the hand. The other hand, the conventional automatic hand sterilizer has a demerit that noise, vibration and a heating phenomenon occurs from an internal since a mechanical apparatus becomes complicated and large by necessarily adding a drying apparatus to an antiseptic solution spraying apparatus.

The present inventor completes the present invention to add an image information apparatus adapted to a use characteristic of a hand sterilizer which is used by all sorts of people and improves the above problems of the conventional hand sterilizer.

### DISCLOSURE OF INVENTION

Accordingly, it is an object of this invention to provide a hand sterilizer having a display device which displays wanted information and is connected to a contactless automatic hand sterilizer which automatically operates when a hand moves towards a sensor without an additional operation through a gel type hand detergent without the need of an extra dryer by improving the function of a hand detergent which has a conventional simple cleaning and sterilizing function to clean the hands. The hand sterilizer has a monitor device which performs a display function while sterilizing one's hands.

In a hand sterilizer unit (100) for a wall attachment which sterilize and disinfects a hand by spraying a hand detergent (170) on the hand through a nozzle (152) to clean the hand which is formed of an outer appearance case by an opening/closing cover (110) having a hinge (121) and a flat type body (120), a monitor (130) which is close proximity to the front penetration hole (111) of the opening/closing cover (110) is detachably attached to a supporting bar (131) on the body (120) and is formed to display an image operated by a detection of a first object detection sensor (116) corresponding to a first sensor hole (112), and a nozzle (152) as a liquid transmission apparatus which is opened/closed by an antiseptic solution receiving unit (151), a circuit receiving unit 153 and an electronic valve (154) which is operated by the detection signal of a second hand detection sensor (117) is installed to spray a hand detergent to a lower side on the inside of the opening hole (113) at a corresponding position of the hand on rear lower area of the monitor (130), and one hand sterilizer with having a high advertisement concentration performing sterilization and monitoring functions.

If a user moves towards the front of the hand sterilizer of the present invention, an object detection sensor (116) which is installed to cover a predetermined angle is operated and outputs predetermined image information through a monitor (130), and if the hand is put in the area of the opening hole (113), a second hand detection sensor (117) which is installed on the inside of the opening hole (113) is operated and enables an non-sticky gel type hand disinfectant which is sprayed automatically.

### BRIEF DESCRIPTION OF THE DRAWINGS

This invention will be described in detail with reference to the attached drawings in with like numerical references.

FIG. 1 is a perspective view showing a total configuration of the present invention.

FIG. 2 is a diagram showing a configuration of an internal apparatus in a state that an opening/closing cover of the present invention is opened.

FIG. 3 is a diagram showing an internal configuration in a state that a monitor apparatus of the present invention is opened.

FIG. 4 is a circuit block diagram showing an electrical configuration of the present invention.

FIG. 5 is a cross-section view of the present invention.

FIG. 6 is an exemplary diagram showing use state of a monitor apparatus of the present invention.

FIG. 7 is an exemplary diagram showing use state of a hand sterilizing unit of the present invention.

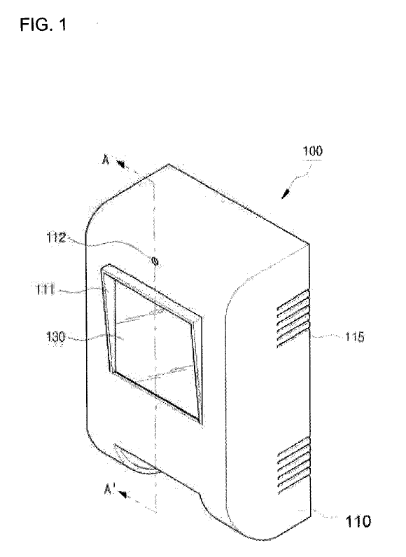

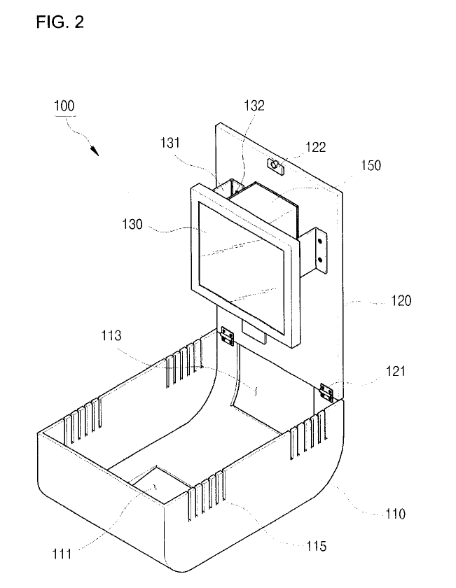

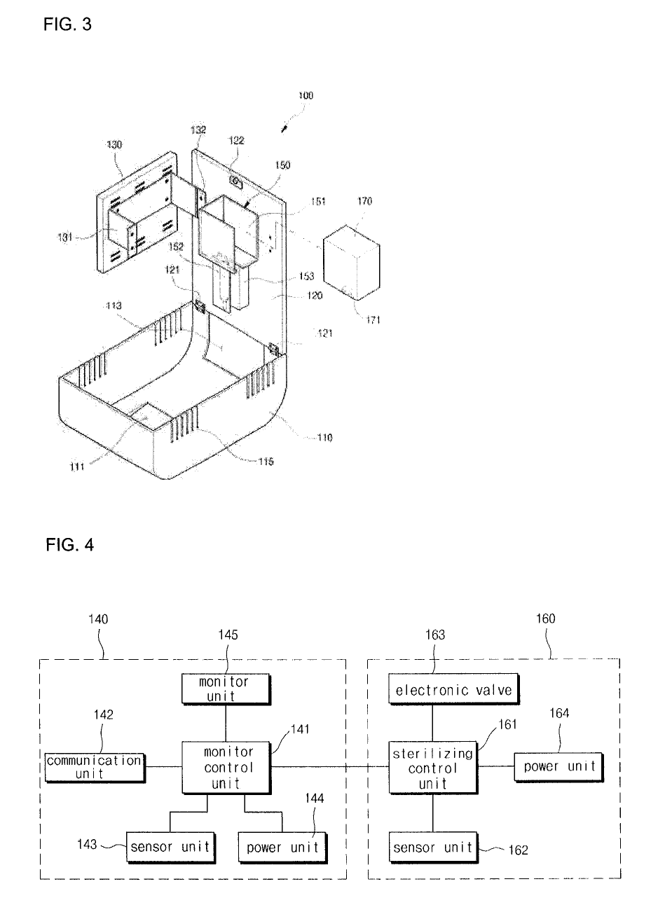

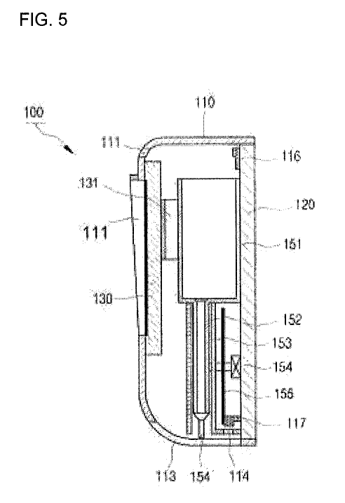

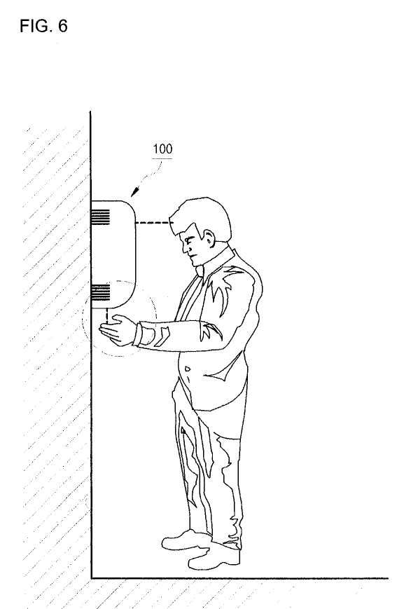

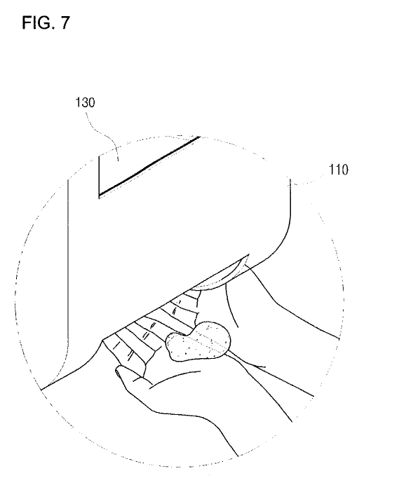

### BEST MODES FOR CARRYING OUT THE INVENTION

To fully understand many objects to be accomplished by various embodiments and operational advantages of this invention, design and components of this invention will be explained with reference to the attached drawings.

Moreover, a circuit configuration of the present invention is divided into a monitor circuit (140) and a sterilizing circuit (160) which are formed to be driven separately or coupled to each other. The monitor circuit (140) includes a communication unit (142), a sensor unit (143), a power unit (144) and a circumference circuit of a monitor unit (145) centered on a monitor control unit (141). The sterilizing circuit (160) includes a sensor unit (162), an electronic valve (163) and a power unit (164) centered on a sterilizing control unit (161).

As mentioned above, the present invention includes an opening/closing cover (110) having a hinge (121) and a body (120) of a non-flammable material of a compact size corresponding to the opening/closing cover (110) to perform an opening/closing type rotation operation. The opening/closing cover (110) and the body (120) form an appearance of a hand sterilizer (100) of a rectangular case shape capable of being installed on a wall plane irrespective of an installation space such as a small space. The screen of a monitor (130) is exposed to a front face of the opening/closing cover (110) through a rectangular hole opening 111. Storage information or real-time online information such as advertisements or public announcements content are displayed on the monitor (130) by an operation of a detection sensor (116). If a hand is put on an opening hole (113) of a lower part of the unit, two functions are performed with monitoring and a sterilization which sprays a hand detergent type gel through a nozzle for a predetermined amount are performed (117).

Further, each of ventilating openings (115) which radiates internal heat of the hand sterilizer on both sides of the opening/closing cover (110). A hinge (121) and a locking unit (122) which opens/closes an opening/closing cover (110) are included in the opening/closing cover (110) to be used conveniently.

The monitor (130) as a general display apparatus which outputs a still picture or a moving picture with sound at the same time includes a remote control unit (141) a micro processor, a communication unit (142), a sensor unit (143), a power unit (144), and a monitor unit 145 (embedded). The remote control will allow the user (141) to predetermine operational programs and controls the monitor (130) by analyzing detected data. The communication unit (142) as a communication interface is connected to a communication hub such as the Internet and receives information. The sensor unit (143) detects an object within a detection region. The power unit (144) smoothes and provides an alternative power. If a detection signal of the sensor unit (143) is inputted to the monitor control unit (141), real-time input information inputted from a storage apparatus (not illustrated in drawings) or the communication unit (142) is outputted to the monitor (130) for a predetermined time. A remote control which controls a determined amount of monitors at a given location may be performed by connecting the monitors to a central computer.

A rear plane of a body of the monitor (130) is fixedly attached to a monitor supporting bar (131) of a supporting leg shape. The monitor (130) is formed to open a sterilizing unit (150) which is located to be overlapped with the rear plane by being detachably attached to a surface of a flat type body (120) through screw or push button type connectors (132).

Moreover, the first detection sensor (116) applied to the present invention detects a change of an infrared ray by radiating the infrared ray within a detection range through a first sensor hole (112) is located on a front plane of the opening/closing cover (110). The first detection sensor (116) adds a stop detection function which detects a stop object or a moving object for a predetermined time, e.g., 2 seconds, 7 seconds, 15 seconds.

Further, as mentioned above, the sterilizing unit (150) is installed on a rear plane of the unit (130) and includes an antiseptic solution receiving unit (151), a nozzle (152), and a circuit receiving unit (153). The antiseptic solution receiving unit (151) receives a hand detergent (170) of a rectangular pack shape. The nozzle (152) of hose shape has an exhaust nozzle coupled to the antiseptic solution receiving unit (151). The circuit receiving unit (153) includes a printed circuit board (155), a solenoid electronic valve (163) and a second hand detection sensor (117). If the hand is detected by the second detection sensor (117), the hand gel is exhausted to the nozzle (152) by operating the electronic valve (154).

The antiseptic solution receiving unit (151) having an opened part is located on an upper part of the nozzle (152) to obtain a potential energy of gravity. To re-fill is easily performed by connecting an end of the nozzle (152) to a lower portion (171) of the hand detergent (170) gel pack. The nozzle (152) which stands inversely on a moving path partitioned by a partition plate of a bottom plane of the antiseptic solution receiving unit (151) is fixedly and vertically connected, and sprays the hand detergent by a liquid transmission mechanism which regularly exits a liquid which is dropped by a self-weight through the outlet (171) of the gel pack (170).

The opening hole (113) which is located at a proper height at the bottom plane of the antiseptic solution receiving unit (151) is formed to include a front plane partially so that the hand is easily inserted into the opening area (113). The second detection sensor (117) is installed on the inside of the opening hole (113). The hand of a user which is inserted into the inside of the opening hole (113) is detected by radiating an infrared ray within a detection range through the second sensor hole (114).

Moreover, as mentioned above, the sterilizing control unit (161) installed on the printed circuit board (155) has an electrical configuration including a sensor unit (162), an electronic valve (163) and a power unit (164) centered on a sterilizing control unit (161). If a signal of the sensor unit (162) which detects an object is inputted to the sterilizing control unit (161) of the microprocessor, the hand detergent (170) is released by applying a control signal and operating the solenoid electronic valve (163) for a predetermined time.

The sterilizing control unit (161) which controls a general operation of each component has a micro processor which is operated by an independent program. The power unit (164) provides a stable operation power to a device by converting and stabilizing an AC power into the DC power.

Further, the sensor of the unit may be replaced by an ultrasonic sensor and have an additional display unit to enable a user to recognize an operation state when it is determined according to an environment of a spot such as a small space.

If a user rubs the non-sticky gel type hand detergent, pathogens and smell are removed since the hand is evaporated and dried without a drying apparatus.

The hand sterilizer having a display device of the implements a fast, efficient, and positive advertisement and guide by outputting image information or public information which are provided in real-time through an Internet computer communication network or additionally stored by adding a hand sterilizer of a conventional independent simple sterilization function to a monitor using a computer and an information communication technology.

In particular, the present invention reduces noise and vibrations by omitting a drying apparatus using a fan and exchanges a hand detergent easily. And, the present invention may be conveniently used by being installed on a small space through a compact wall hanger type, and performs an efficient advertisement at a public space such as a school or an academy by improving the concentration of the advertisement.

1. In a hand sterilizer for a wall attachment which sterilize and disinfects a hand by spraying a hand detergent on the hand through a nozzle to clean the hands and skin which is incased by an opening/closing cover having a hinge and a flat type body,
An LCD monitor which is located on front face hole of the opening/closing cover is detachably attached to a supporting bar on the body and is designed to display an image operated by a detection signal of a first human body detection sensor corresponding to a first sensor hole, and a nozzle as a liquid transmission apparatus which is opened/closed by an antiseptic solution receiving unit, a circuit receiving unit and an electronic valve which is operated by the detection signal of a second detection sensor is installed to dispense a hand detergent type gel to the lower side on the inside of the opening hole at a corresponding position of the hand on a rear plane of the monitor, and one hand sterilizer having a high advertisement concentration performs sterilization and monitor display functions.

2. The hand sterilizer according to claim 1, wherein a rear plane of a body of the monitor is fixedly attached to a monitor supporting bar of a supporting leg shape, and the monitor is formed to open a sterilizing unit which is located to be overlapped with the rear plane by being detachably attached to a surface of a flat type body through screw or push button type monitor connectors.

3. The hand sterilizer according to claim 1, wherein the antiseptic solution receiving unit having an opened part is located on an upper part of the nozzle to obtain a potential energy of gravity, and the nozzle which stands inversely on a moving path partitioned by a partition plate of a bottom plane of the antiseptic solution receiving unit is fixedly and vertically connected and dispenses the hand detergent type gel by a liquid transmission mechanism which regularly exhausts a liquid which is dropped by a self-weight through the outlet of the hand detergent gel pack.
